(19) United States
(12) Patent Application Publication
(10) Pub. No.: US 2026/0277286 A1
(43) Pub. Date: Sep. 17, 2026

(54) METHOD FOR POWER MODE MANAGEMENT OF AN INTERCONNECTION PROTOCOL IN AN ELECTRONIC DEVICE AND ELECTRONIC DEVICE

(71) Applicant: SK hynix Inc., Icheon-si Gyeonggi-do (KR)

(72) Inventors: LANFENG WANG, Zhubei City Hsinchu County (TW); WEN JYH LIN, Zhubei City Hsinchu County (TW)

(73) Assignee: SK hynix Inc., Icheon-si Gyeonggi-do (KR)

(21) Appl. No.: 19/169,643

(22) Filed: Apr. 3, 2025

(30) Foreign Application Priority Data
Mar. 12, 2025 (TW) 114109027

(51) Int. Cl. G06F 1/26

(52) U.S. Cl. CPC G06F 1/26

(57) ABSTRACT

Method for power mode management of an interconnection protocol in an electronic device and an electronic device configured to communicate with another electronic device using an interconnection protocol are provided. The method comprises a plurality of steps as follows. A power mode for a forward link is determined by the electronic device, based on version information of the interconnection protocol of another electronic device, wherein the version information of the interconnection protocol of the another electronic device is obtained in a first stage of link initialization. The electronic device operates in the power mode for the forward link for a second stage of the link initialization following the first stage of the link initialization.

### BACKGROUND OF THE INVENTION

### 1. Cross-Reference to Related Application

The present application claims priority under 35 U.S.C. § 119(a) to Taiwanese patent application number 114109027 filed on Mar. 12, 2025, in the Taiwanese Intellectual Property Office, the entire disclosure of which application is incorporated by reference herein.

### 2. Field of the Invention

The present disclosure relates to circuit, controllers, and methods for frame transmission for an electronic device, and in particular to circuits, controllers, and methods for frame transmission for an interconnection protocol, and an electronic device.

### 3. Description of the Related Art

The Mobile Industry Processor Interface (MIPI) alliance developed interconnection protocol technology, for example, MIPI M-PHY specification associated with a physical layer and MIPI UniPro specification associated with a Unified Protocol (UniPro), for interconnection from one chip to another inside the mobile devices or those affected by the mobile devices in order to implement higher transmission speeds and low power consumption operations. On the other hand, the Joint Electron Device Engineering Council (JEDEC), using the MIPI M-PHY specification and the MIPI UniPro specification, launched a high-performance non-volatile memory standard that is referred to as Universal Flash Storage (UFS). The UFS standard realizes gigabit-level high-speed transmissions and low-power operations, and provides the functionality and expandability required for advanced mobile systems (for example, computing devices such as smartphones, tablet computers, multimedia devices, and wearable devices) to facilitate rapid adoption by the industry.

A system implemented according to the UFS standard or UniPro specification includes a local host (e.g., a computing device or chip) and a remote device (e.g., a storage device or another chip). During a boot process of the system, a link startup process is performed to establish a bidirectional link between the local host and the remote device. A huge amount of data for the link startup process are required to be transferred over the link during the link startup process. Opening and then closing bursts occurs between the local host and the remote device for a number of times. The elapse of time periods for burst opening and burst closing for the data transfer is inevitable. In implementation, the data transfer during the link startup process according to the UniPro specification (e.g., UniPro version 2.0) results in a certain amount of overall data transfer time and also latency in the boot process.

### BRIEF SUMMARY OF THE INVENTION

In the present disclosure, technologies for power mode management of an interconnection protocol in an electronic device are provided, and are suitable for an electronic device, which is configured to communicate with another electronic device using the interconnection protocol. The technologies can achieve higher data transfer performance through reduction in burst opening and closing during a system boot process.

Embodiments of a method for power mode management of an interconnection protocol in an electronic device are provided. The method comprises a plurality of steps (or operations) as follows. a) A power mode for a forward link is determined by the electronic device, based on version information of the interconnection protocol of another electronic device, wherein the version information of the interconnection protocol of the another electronic device is obtained in a first stage of link initialization. b) The electronic device operates in the power mode for the forward link for a second stage of the link initialization following the first stage of the link initialization.

Embodiments of an electronic device configured to communicate with another electronic device using an interconnection protocol are provided. The electronic device can be implemented as a host device, a storage device, or a chip. The electronic device comprises an interconnection controller, which includes a physical layer circuit for signal transmission and a link controller coupled to the physical layer circuit. The interconnection controller is configured to perform a plurality of operations includes the following. a) A power mode for a forward link is determined based on version information of the interconnection protocol of another electronic device, wherein the version information of the interconnection protocol of the another electronic device is obtained in a first stage of link initialization. b) The interconnection controller of the electronic device operates in the power mode for the forward link for a second stage of the link initialization following the first stage of the link initialization.

In some embodiments of the method or the electronic device, in the step or operation a), the version information indicates that a version value of the interconnection protocol used in the another electronic device is equal to or greater than a version threshold, and the power mode for the forward link is determined as a first transmission mode in which the forward link is ready to transmit data without autonomously being switched to be inactive.

In some embodiments of the method or the electronic device, the plurality of steps or operations further comprises: c) opening, by the electronic device, a burst for the forward link in the first transmission mode for the second stage of the link initialization; and d) maintaining, by the electronic device, the burst opened for the forward link until a condition which requires burst closing is detected.

In some embodiments of the method or the electronic device, the condition which requires burst closing is one of a power mode change, a hibernate entry, or an error handling condition.

In some embodiments of the method or the electronic device, the interconnection protocol is based on a Unified Protocol (UniPro); the version threshold indicates a version number higher than version 2.0; and the first transmission mode is a fast mode of the Unipro.

In some embodiments of the method or the electronic device, the first stage of the link initialization is a process for link startup for a physical adapter layer and the second stage of the link initialization is data link layer initialization.

In some embodiments of the method or the electronic device, in the step or operation a), the version information indicates that a version value of the interconnection protocol used in the another electronic device is less than a version threshold, and the power mode for the forward link is determined as a second transmission mode in which the forward link is ready to transmit data and is autonomously being switched to be inactive when no data is to be transmitted.

In some embodiments of the method or the electronic device, the interconnection protocol is based on a Unified Protocol (UniPro); the version threshold indicates a version number higher than version 2.0; and the second transmission mode is a fast auto mode of the UniPro.

### BRIEF DESCRIPTION OF THE DRAWINGS

FIG. 1 is a block diagram illustrating an embodiment of a communication system capable of communication according to an interconnection protocol.

FIG. 2 is a flowchart illustrating an embodiment of a method for power mode management of an interconnection protocol in an electronic device.

FIG. 3 is a timing diagram illustrating an embodiment of a link startup process with respect to a first device.

FIG. 4 is a flowchart illustrating an embodiment of a method for power mode management of an interconnection protocol in an electronic device based on FIG. 2.

FIG. 5 is a timing diagram illustrating another embodiment of a link startup process with respect to a first device.

FIG. 6 is a flowchart illustrating an embodiment of a method for power mode management of an interconnection protocol in an electronic device.

FIG. 7 is a timing diagram illustrating an embodiment of hibernate exit with respect to a first device.

FIG. 8 is a timing diagram illustrating another embodiment of hibernate exit with respect to a first device.

FIG. 9 is a diagram illustrating an example of turnaround overhead due to burst opening.

FIG. 10 is a diagram illustrating an embodiment of circuit architecture for power mode management of an interconnection protocol in an electronic device.

FIG. 11A is a diagram illustrating circuit architecture of a storage system for an interconnection protocol according to an embodiment of the present disclosure.

FIG. 11B is a block diagram illustrating circuit architecture applicable to the controller in FIG. 11A for the interconnection protocol according to an embodiment of the present disclosure.

FIG. 11C is a block diagram illustrating circuit architecture applicable to the controller in FIG. 11A for the interconnection protocol according to an embodiment of the present disclosure.

FIG. 12 is a schematic diagram of an embodiment of a layered structure of the storage system in FIG. 11a according to the interconnection protocol.

### DETAILED DESCRIPTION OF THE INVENTION

To facilitate understanding of the object, characteristics and effects of this present disclosure, embodiments together with the attached drawings for the detailed description of the present disclosure are provided.

During a boot process of a system implemented according to the UFS standard or UniPro specification and including a local host (e.g., a computing device or chip) and a remote device (e.g., a storage device or another chip), a link startup process is performed to establish a bidirectional link between the local host and the remote device. The link startup process includes a link startup sequence (or referred to as link startup) and data link layer initialization. Transferring a huge amount of data for link initialization between the local host and the remote device during the link startup process requires opening and then closing bursts sequentially therebetween. According to the UniPro specification (e.g., UniPro version 2.0 or lower version), after the link startup sequence, both the local host and the remote device enter a type of power mode referred to as “auto mode” hereinafter (e.g., SlowAuto_Mode or FastAuto_Mode as specified in the UniPro specification such as UniPro version 2.0) for the data link layer initialization. In an auto mode, the link is ready for data transfer but can autonomously be switched to be inactive (or in a power saving state such as a stall or sleep state) when no data is to be transferred. Entering an auto mode implies that after the link startup, gaps exist between data transfers. A data transfer needs a new burst opened and the bursts for the data transfers with times for burst opening and closing increase the overall data transfer time for the data link layer initialization. As a result, latency for the boot process increases.

Accordingly, the link startup process has a latency issue as described above. The inventor observes that the latency issue can be reduced or resolved by adopting an advanced approach to power mode management to set or change the power mode to a transmission mode such as fast mode instead of an auto mode after the link startup sequence is completed successfully so that data transfers can be performed effectively and efficiently at least during the data link layer initialization. In other words, the auto mode as specified in the UniPro specification (e.g., UniPro version 2.0 or lower version) can be disabled in an appropriate situation or period. This approach to power mode management may be implemented in a system based on a modified or higher version of the UniPro specification (e.g., UniPro of version higher than 2.0; UniPro version 3.0 or higher version).

Accordingly, in the present disclosure, embodiments of methods for power mode management of an interconnection protocol in an electronic device are provided, and are suitable for an electronic device configured to communicate with another electronic device using the interconnection protocol. In some embodiments, the methods can achieve higher data transfer performance through reduction in opening and closing of bursts during a system boot process, in particular, when both the electronic devices communicated with each other are implemented according to the interconnection protocol based on a modified or higher version of the UniPro specification in which the advanced approach to the power mode management is adopted. In some embodiments, when an electronic device using the interconnection protocol based on the modified or higher version of the UniPro specification initializes communication with another electronic device using the interconnection protocol based on a version of the UniPro specification which does not adopt the advanced approach to the power mode management, the power mode for both of the electronic devices can be set to an auto mode as required by the current version of UniPro (e.g., UniPro version 2.0 or lower version) for compatibility purposes after the link startup.

Various embodiments for the advanced approach to power mode management of an interconnection protocol in an electronic device are provided as follows.

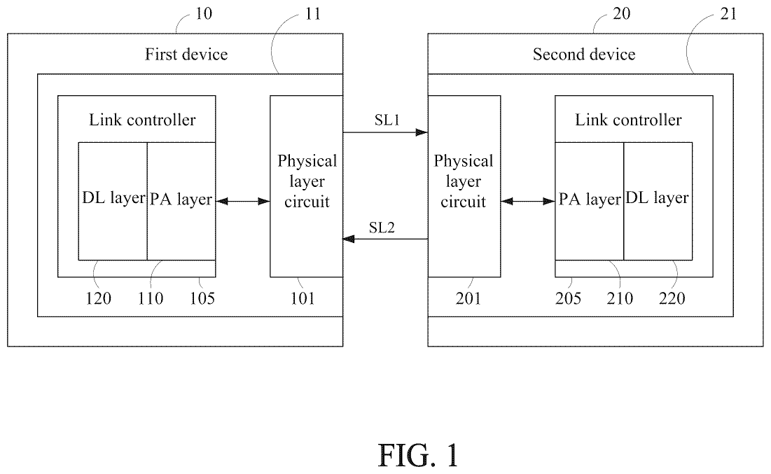

FIG. 1 is a block diagram illustrating an embodiment of a communication system capable of communication according to an interconnection protocol. The interconnection protocol may be based on a UniPro specification, a UFS system, or other related communication protocols or specifications, and so on, whenever appropriate. The communication system, for example, includes a first device 10 and a second device 20, which can be a local host and a remote device respectively, or vice versa. In FIG. 1, the first device 10 includes a physical layer circuit 101 for signal transmission and a link controller 105, which may be implemented as an interconnection controller 11. Likewise, the second device 20 includes a physical layer circuit 201 for signal transmission and a link controller 205, which may be implemented as an interconnection controller 21. The link controller 105 of the first device 10 for example implements a protocol layer of the interconnection protocol (or “link layer,” with respect to the physical layer such as M-PHY) such as a modified UniPro layer including such as a physical adapter (PA) layer 110, a data link (DL) layer 120, and so on. Likewise, the link controller 205 of the second device 20 for example also implements the protocol layer (or “link layer”) such as a modified UniPro layer including such as a physical adapter (PA) layer 210, a data link (DL) layer 220, and so on. The first device 10 is capable of communicating with the second device 20 through a link including at least one data lane SL1 and at least one data lane SL2, which are bidirectional, according to the interconnect protocol. For example, the interconnection protocol is applicable to a wide range of device types (e.g., for first device or second device) such as application processors, co-processors, modems, storage subsystems including non-volatile memory modules, storage devices or chips for automotive applications, displays, camera sensors, 3D graphics and multimedia accelerators, chips, and so on. It is also applicable to different types of data traffic such as control messages, bulk data transfer and packetized streaming. Other related MIPI alliance specifications or other related specifications can also be used for implementation of the physical layer or application layer, whenever appropriate.

In some embodiments, at least one of the first device 10 and the second device 20 is implemented according to the interconnection protocol based on a modified or higher version of the UniPro specification in which the advanced approach to the power mode management is adopted.

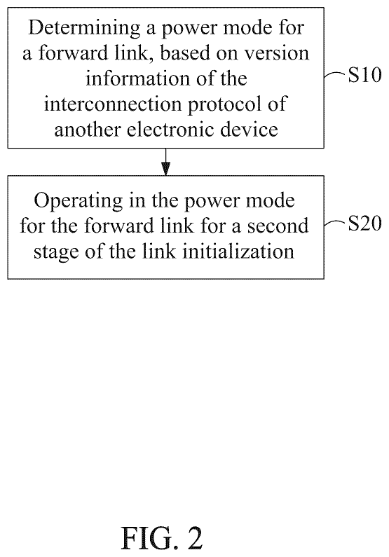

FIG. 2 is a flowchart illustrating an embodiment of a method for power mode management of an interconnection protocol in an electronic device. In this embodiment, the electronic device (e.g., first device 10 (or second device 20)) is implemented according to the interconnection protocol based on a modified or higher version of the UniPro specification (e.g., UniPro of version higher than 2.0; UniPro version 3.0 or higher version) in which the advanced approach to the power mode management is adopted. As shown in FIG. 2, the method comprises a plurality of steps such as step S10 and S20 as follows.

In step S10, a power mode for a forward link (e.g., a sub-link via the data lane SL1) is determined by the electronic device (e.g., first device 10), based on version information of the interconnection protocol of another electronic device (e.g., second device 20), wherein the version information of the interconnection protocol of the another electronic device is obtained in a first stage of link initialization.

In step S20, the electronic device (e.g., first device 10) operates in the power mode for the forward link for a second stage of the link initialization following the first stage of the link initialization.

In some embodiments of the method, the first stage of the link initialization is a link startup sequence for a physical adapter layer (e.g., PA layer 105) of the interconnection protocol (e.g., link startup sequence of the UniPro specification) and the second stage of the link initialization is data link layer initialization (e.g., for DL layer 120) of the interconnection protocol (e.g., data link layer initialization of the Unipro specification).

In an embodiment of the method, in the step S10, the version information indicates that a version value of the interconnection protocol used in the another electronic device (e.g., second device 20) is equal to or greater than a version threshold, and the power mode for the forward link is determined as a first transmission mode in which the forward link is ready to transmit data without autonomously being switched to be inactive. For example, the interconnection protocol is based on a modified or higher version of UniPro (e.g., UniPro of version higher than 2.0; UniPro version 3.0 or higher version); the version threshold indicates a version number higher than version 2.0 (e.g., UniPro version 3.0); and the first transmission mode is a fast mode of the UniPro.

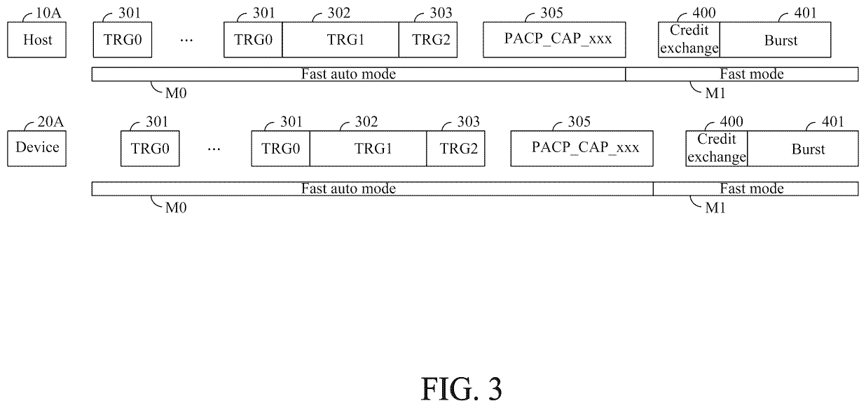

FIG. 3 is a timing diagram illustrating an embodiment of a link startup process with respect to a first device for the sake of brevity. In FIG. 3, a host 10A and a device 20A, which are examples of the first device 10 and the second device 20 respectively in FIG. 1, are illustrated to perform a plurality of operations (e.g., indicated by blocks 301 to 401) for the link startup process with respect to the host 10A. Likewise, the link startup process is performed with respect to the device 20A with the similar operations as shown in FIG. 3 in an opposite direction (not shown for brevity's sake). In this embodiment, both the first device 10 and the second device 20 are implemented according to the interconnection protocol based on a modified or higher version of the UniPro specification (e.g., UniPro of version higher than 2.0; UniPro version 3.0 or higher version) in which the advanced approach to the power mode management is adopted. The link startup process includes a link startup sequence for PA layer and data link (DL) layer initialization, based on the UniPro specification. The link startup sequence for PA layer (e.g., UniPro version 2.0) includes multiple phases (e.g., Phases 0, 0b, 1, 2, 3,4, 5 described in the UniPro specification) for exchanging trigger events and exchanging capability information of both devices (e.g., host 10A and device 20A) to establish an initial link for forward and reverse directions. The data link layer initialization includes initial flow control information (e.g., credit) exchange, and is the process of preparing the link to execute its normal operation (e.g., acknowledgment and flow control (AFC) frames are transmitted).

In FIG. 3, an amount of trigger events TRG0, TRG1, and TRG2 indicated by blocks 301, 302, and 303 respectively, for example, triggers TRG_UPR0, TRG_UPR1, TRG_UPR2 for Phase 0 to Phase 4 of the link startup sequence as described in the UniPro specification, are transmitted sequentially from the host 10A to the device 20A, for example, from a PA layer (e.g., a PA transmitter) of the host 10A to a PA layer (e.g., a PA receiver) of the device 20A. For Phase 5, a plurality of capability frames, indicated by a block 305 with legend PACP_CAP_xxx, such as PACP_CAP_EXT2_ind, PACP_CAP_EXT1_ind, PACP_CAP_ind described in the UniPro specification, are transmitted to the device 20A. In FIG. 3, the device 20A receives the trigger events and the capability frames along with delay times. Corresponding trigger events and capability frames for Phase0 to Phase 5 are also transmitted in an opposite direction from the device 20A to the host 10A (not shown for brevity's sake).

According to the UniPro specification, during the phase 5 of the link startup sequence according to the UniPro specification, capability downgrading which settles down the limitation of operations for both sides is performed after the capability frames exchange between both sides are completed. During the capability frames exchange of the phase 5 of the link startup sequence for PA layer, the information of UniPro version of a peer side (e.g., second device 20 such as device 20A) can be extracted from the PACP_CAP_ind frame received by the host 10A from the device 20A, and vice versa. According to the UniPro specification, a PACP_CAP_ind frame has a field “VersionInfo” which specifies the local UniPro version of the side that transmits that frame. The version of the peer side and/or the version of the local side can be used as parameter(s) or information for determining attributes for the capability downgrading.

As described above, the advanced approach to the power mode management is to set or change the power mode to a transmission mode such as fast mode instead of an auto mode, or disable the auto mode, after the link startup sequence is completed successfully so that data transfers can be performed effectively and efficiently at least during the data link layer initialization. In an embodiment, a determination can be made based on the step S10 of the method of FIG. 2 and applied to the capability downgrading to determine the power mode for a forward link (or referred to the link in the forward direction, or outbound link) with respect to the host 10A (e.g., first device 10). The determination can be made based on the step S10 with one or more conditions. If the one or more conditions are met, the power mode is set or changed to a fast mode (e.g., Fast_Mode when ResetMode==HS_MODE for the UniPro specification) rather than FastAuto_Mode (e.g., when ResetMode==HS_MODE). Alternatively, the power mode can be set or changed to or a slow mode (e.g., Slow_Mode when ResetMode==LS_MODE for the UniPro specification) rather than SlowAuto_Mode (e.g., when ResetMode==LS_MODE). In this manner, the usage of an auto mode (e.g., FastAuto_Mode described in the UniPro specification) is disabled after the PA layer's link startup sequence is completed successfully. The condition(s) for the determination can be implemented based on the version of the peer side and/or the version of the local side in various manners. In an example, in the host 10A, it is determined whether the version of the peer side (e.g., device 20A) is equal to or greater than a version threshold (e.g., a value 7 indicating UniPro above version 2.0 as described in the UniPro specification and UniPro version 2.0 is the current version). If the value of the field “VersionInfo” of the PACP_CAP_ind frame obtained during the link startup sequence is a value 7, the power mode for the forward link (e.g., from the host 10A to the device 20A) with respect to the host 10A is set or changed to a fast mode (as indicated by a bar M1 in FIG. 3), rather than the fast auto mode (as indicated by a bar M0 in FIG. 3). As illustrated in FIG. 3, after the link startup sequence is completed successfully (e.g., after the block 305), the host 10A operates in the fast mode for the data link layer initialization, based on the step S20 of the method in FIG. 2. During the data link layer initialization, a burst, indicated by blocks including blocks 400 and 401, for the forward link is opened for control information exchange (e.g., credit exchange as indicated by a block 400) in the fast mode. In the fast mode, the forward link is ready to transmit data without autonomously being switched to be inactive. The above operations for the link startup sequence and data link layer initialization with the operations based on the steps S10 and S20 are performed by the host 10A which establishes a forward link to the device 20A, and vice versa.

In addition, in the above embodiment and its related examples related to FIG. 3, it is supposed that the electronic device (e.g., host 10A or device 20A) uses a UniPro of version above a current version such as version 2.0 and thus the determination based on the step S10 can be made and applied to the electronic device (e.g., host 10A or device 20A) based on the version information of the peer side (e.g., device 20A or host 10A).

In some embodiments, the determination based on the step S10 can be made and applied to the electronic device (e.g., host 10A or device 20A) based on the version of the peer side and the version of the local side. In an example, in the host 10A, it is determined whether both versions of the peer side and local side (e.g., UniPro version) are equal to or greater than a version threshold (e.g., a value 7 indicating UniPro above version 2.0 as described in the UniPro specification and UniPro version 2.0 is the current version). If so, the power mode is determined as a fast mode; otherwise, the power mode is determined as a fast auto mode. For example, the version of the peer side can be the value of the field “VersionInfo” of the PACP_CAP_ind frame obtained from the peer side or can be the value of an attribute PA_RemoteVerinfo stored in the local side, which is available after the link startup sequence is completed successfully, according to the UniPro specification. For example, the value of the local side can be an attribute (e.g., PA_LocalVerinfo as described in the UniPro specification) indicating local version information stored in the local side.

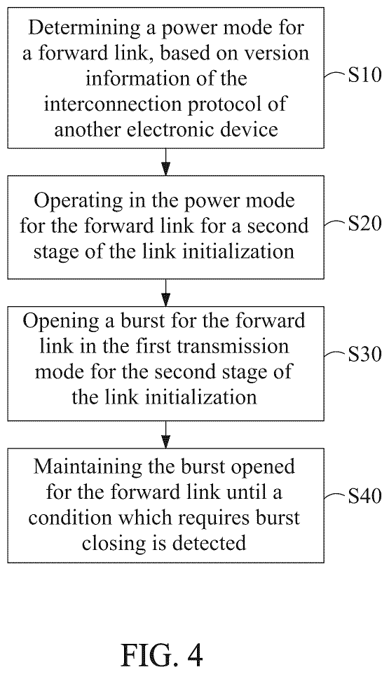

FIG. 4 illustrates another embodiment of a method for power mode management of an interconnection protocol in an electronic device based on FIG. 2. In this embodiment, both the first device 10 and the second device 20 are implemented according to the interconnection protocol based on a modified or higher version of the UniPro specification in which the advanced approach to the power mode management is adopted. As shown in FIG. 4, the method based on FIG. 2 further comprises steps S30 and S40.

In step S10, a power mode for a forward link (e.g., a sub-link via the data lane SL1) is determined by the electronic device (e.g., first device 10), based on version information of the interconnection protocol of another electronic device (e.g., second device 20). The power mode is determined as a first transmission mode (e.g., a fast mode) because both of the electronic device and another electronic device (e.g., first device 10 and second device 20) use the interconnection protocol based on a modified or higher version of UniPro.

In step S20, the electronic device (e.g., first device 10) operates in the power mode for the forward link for a second stage of the link initialization following the first stage of the link initialization, wherein the power mode is the first transmission mode (e.g., the fast mode).

In step S30, a burst for the forward link (e.g., via the data lane SL1) is opened in the first transmission mode for the second stage of the link initialization.

In step S40, the burst opened for the forward link is maintained until a condition which requires burst closing is detected.

In some embodiments of the method based on FIG. 4, the condition which requires burst closing is one of a power mode change, a hibernate entry, or an error handling condition, for example, as described in the UniPro specification or additional condition, whenever appropriate.

In some embodiments of the method based on FIG. 4, the interconnection protocol is based on a Unified Protocol (UniPro); the version threshold indicates a version number higher than version 2.0; and the first transmission mode is a fast mode of the UniPro.

In some embodiments of the method based on FIG. 4, the first stage of the link initialization is a link startup sequence for a physical adapter layer and the second stage of the link initialization is data link layer initialization.

In some embodiments, in implementation of the link startup process, the method based on FIG. 2, FIG. 4, or one of the related embodiments can apply to at least one of the first device 10 and second device 20.

In some embodiments, the method related to FIG. 2, FIG. 3, or FIG. 4 (or one or more their embodiments and related examples) is applied to the second device 20 and in these embodiments, the second device 20 is implemented according to the interconnection protocol based on a modified or higher version of the UniPro specification (e.g., UniPro of version higher than 2.0; UniPro version 3.0 or higher version) in which the advanced approach to the power mode management is adopted.

In some embodiments of the method based on FIG. 2, if the first stage of the link initialization (e.g., the PA layer's link startup sequence) is completed successfully and the version of both sides on the UniPro link is a modified or higher version of UniPro (e.g., UniPro version 3.0 or above), the power mode of each direction of the UniPro link is set to Fast_Mode. After the TX_Burst of each side on UniPro link is asserted (or opened) for the DL layer initialization for the link startup process, the TX_Burst will not be closed until the power mode change, hibernate enter or error handling conditions are detected. According to M-PHY specification, the TX_Burst is a signal of the signaling interface between the UniPro and M-PHY.

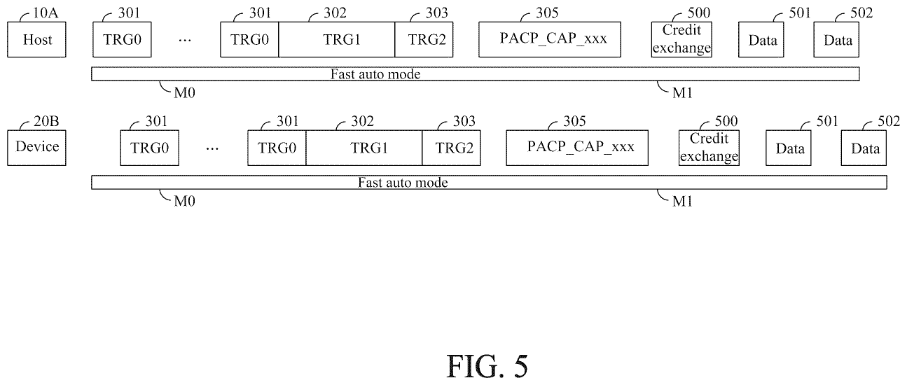

In an embodiment of the method based on FIG. 2, in the step S10, the version information indicates that a version value of the interconnection protocol used in the another electronic device is less than a version threshold, and the power mode for the forward link is determined as a second transmission mode in which the forward link is ready to transmit data and is autonomously being switched to be inactive when no data is to be transmitted. For example, the interconnection protocol is based on a Unified Protocol (UniPro); the version threshold indicates a version number higher than version 2.0; and the second transmission mode is a fast auto mode of the UniPro. Regarding this, FIG. 5 illustrates another example of a timing diagram of a link startup process with respect to a first device, wherein the fast auto mode is entered. In the embodiment of FIG. 5, only one of host 10A and device 20B (which are examples of the first device 10 and the second device 20) is implemented according to the interconnection protocol based on the modified or higher version of the UniPro specification and the other one of the first device 10 and the second device 20 is implemented according to the interconnection protocol based on a current version of the UniPro specification (e.g., UniPro version 2.0 or lower version). As illustrated in FIG. 5, the data link layer initialization is performed in the fast auto mode, as indicated by the bar M1, and credit exchange 500 and data 501 and 502 require multiple data transfer using a plurality of bursts opening and closing.

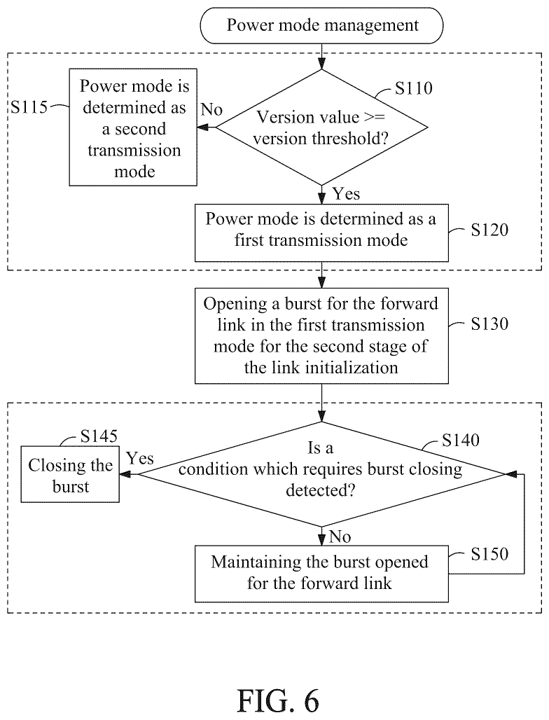

FIG. 6 is a flowchart illustrating an embodiment of a method for power mode management of an interconnection protocol in an electronic device. In this embodiment, the electronic device (e.g., first device 10 (or second device 20)) is implemented according to the interconnection protocol based on a modified or higher version of the UniPro specification (e.g., UniPro of version higher than 2.0; UniPro version 3.0 or higher version) in which the advanced approach to the power mode management is adopted.

In step S110, it is determined whether a version value of the interconnection protocol of another electronic device (e.g., second device 20) is equal to or greater than a version threshold, wherein version information of the interconnection protocol of the another electronic device indicating the version value is obtained in a first stage of link initialization. If the version value of the interconnection protocol of another electronic device (e.g., second device 20) is equal to or greater than the version threshold, step S120 is performed. If not, step S115 is performed. For example, the interconnection protocol is based on a modified or higher version of UniPro (e.g., UniPro of version higher than 2.0; UniPro version 3.0 or higher version); the version threshold indicates a version number higher than version 2.0.

In step S120, the power mode for the forward link is determined as a first transmission mode in which the forward link is ready to transmit data without autonomously being switched to be inactive. For example, the first transmission mode is a fast mode of the UniPro specification.

In step S115, the power mode for the forward link is determined as a second transmission mode in which the forward link is ready to transmit data and is autonomously being switched to be inactive when no data is to be transmitted. For example, the second transmission mode is a fast auto mode of the UniPro specification.

In step S130, a burst for the forward link (e.g., via the data lane SL1) is opened in the first transmission mode for the second stage of the link initialization.

In step S140, it is determined whether the burst opened for the forward link is maintained until a condition which requires burst closing is detected. For example, the condition which requires burst closing is one of a power mode change, a hibernate entry, or an error handling condition.

If a condition which requires burst closing is detected, step S145 is performed to close the burst opened for the forward link. If it is not detected, step S150 is performed to maintain the burst opened for the forward link.

Regarding power mode management during power mode change, in an embodiment, after the first stage of the link initialization (e.g., link startup sequence) is completed successfully and the versions of both sides on a UniPro link is based on a modified or higher version of UniPro, the power mode of both forward and backward links (or referred to as transmission (TX) and receiving (RX) paths) is Fast_Mode (or Slow_Mode). In this embodiment, if a power mode change is requested to switch the power mode of either UniPro link direction to FastAuto_Mode or SlowAuto_Mode, the power mode change request is rejected with PowerChangeResultCode=PWR_ERROR_CAP and no effective power mode change occurs.

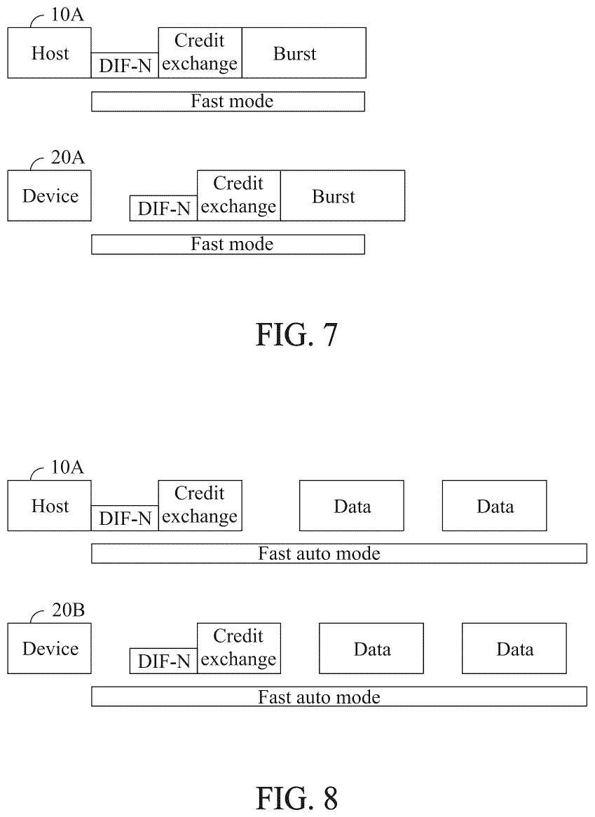

Regarding power mode management after hibernate exit, in an embodiment, after the first stage of the link initialization (e.g., link startup sequence) is completed successfully and the UniPro version of both sides is UniPro v3.0 or higher, the power mode for both TX/RX path is set to Fast_Mode or Slow_Mode. In this embodiment, the power mode is not allowed to switch to FastAuto_Mode or SlowAuto_Mode for the power mode change request. Before UniPro link enters the Hibernate state, its power mode for both TX path and RX path on the UniPro link is either the Fast_Mode or the Slow_Mode. At the early stage of the Hibernate Exit sequence, values of PA_PWRMode will be restored and power mode for TX/RX path is resumed to the same as before Hibernate state is entered, which is Fast_Mode or Slow_Mode. Regarding this, FIG. 7 illustrates an example of a timing diagram of hibernate exit with respect to a first device. In FIG. 7, after Hibernate exit, the power mode is restored to the fast mode. It is noted that after the TX_Burst of each side on the UniPro link is asserted (or opened) for the DL layer initialization for Hibernate Exit sequence, the burst is sustained (or maintained) until a condition which requires burst closing is detected. The condition which requires burst closing can be a power mode change, hibernate entry, or an error handling condition.

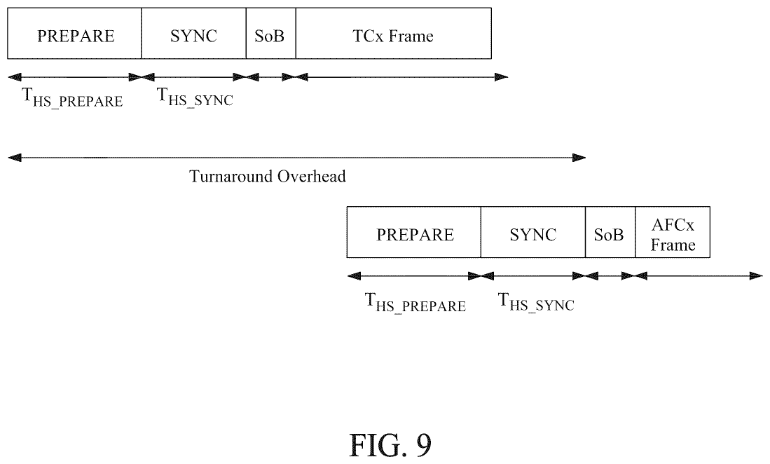

FIG. 8 is a diagram illustrating another example of a timing diagram of hibernate exit with respect to a first device. In FIG. 8, the example follows the embodiment as shown in FIG. 5. Before UniPro link enters the Hibernate state, its power mode for both TX path and RX path on the UniPro link is either the FastAuto_Mode or the SlowAuto_Mode. At the early stage of the Hibernate Exit sequence, values of PA_PWRMode will be restored and power mode for TX/RX path is resumed to the same as before Hibernate state is entered, which is FastAuto_Mode or the SlowAuto_Mode.

The following described performance improvement which can be achieved by the advanced approach to power mode management as illustrated in the above embodiments.

The proposed advanced approach to power mode management can be employed to improve the overall data transfer performance after the first stage of the link initialization is completed successfully for both sides of the devices using a modified or higher version of the UniPro specification. According to the current UniPro specification (e.g., version 2.0), flow control is used for buffer management during data transfer. The data link layer utilizes a dedicated credit flow control scheme per traffic class (TC). The transmitter can keep track of the amount of free logical buffer space in the receiver. This allows the transmitter to start transmitting a data frame of a traffic class if the peer receiver has free logical buffer space for this complete data frame of the traffic class.

The AFC sending node sets the AFC credit value field with the contents of A when an AFC Frame is sent. At the same time, the value of S is replaced by the value of A.

For the original transmission of a data frame, a node is allowed to send at most the number of bytes given by Equation 1:
[((R+2^{DL_CreditValSizeBits}—U) mod 2^{DL_CreditValSizeBits})×DL_CreditUnitSize−Part_U] bytes, where DL_CreditValSizeBits is the number of bits used to represent Credit Value field in AFC Frame and DL_CreditUnitSize is the size of one credit unit in bytes. It is noted that the term “(R+2^{DL_CreditValSizeBits}—U) mod 2^{DL_CreditValSizeBits}” addresses wrap-around issues, and avoids negative numbers in the result.

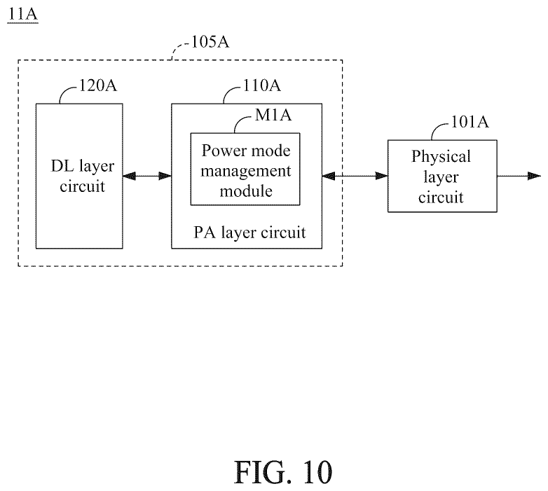

If the TX path is at FastAuto_Mode or SlowAuto_Mode, an AFC sending can happen in a new opened burst. Then, the total cost for an AFC turn-around time will be 2*(T_{XX_PREPARE}+T_{XX_SYNC}). XX may be high speed (HS) or low speed (LS). In this regard, FIG. 9 illustrates an embodiment of cost of burst opening in high speed (HS) case. For example, the total cost for an AFC turn-around time will be about 2*(T_{HS_PREPARE}+T_{HS_SYNC})=2*(120.1923 ns+32820.5 ns)=65881.3846 ns for high speed. T_{HS_PREPARE} and T_{HS_SYNC} indicate the lengths of time for a PREPARE period and a SYNC period of a burst, respectively, in the case of HS-G1 rate A operation at 1248 Mbps (as described in the M-PHY specification).

With the proposed advanced approach to power mode management for disabling the FastAuto_Mode and SlowAuto_Mode after the first stage of the link initialization is completed successfully, this long delay can be avoided and the performance can be improved.

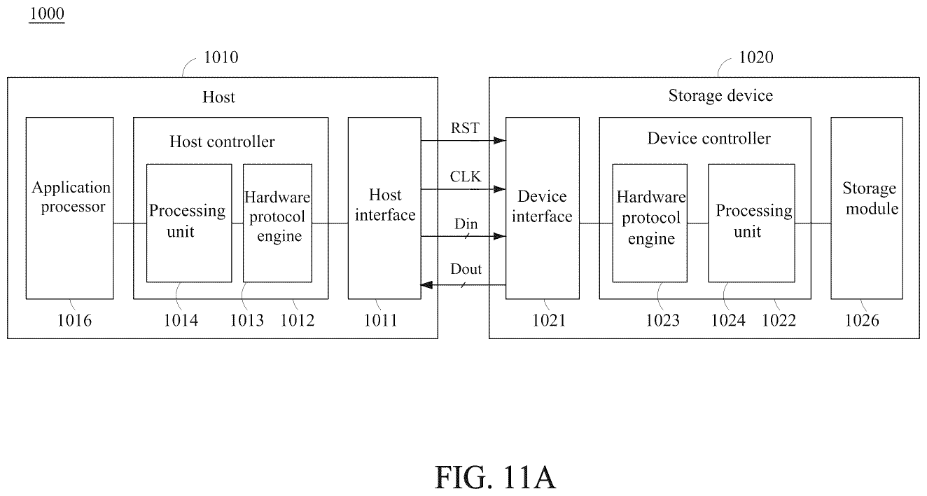

FIG. 10 is a diagram illustrating an embodiment of circuit architecture for power mode management of an interconnection protocol in an electronic device. In FIG. 10, an interconnection controller 11A is shown, providing an architecture for hardware implementation of an interconnection controller, which can be regarded as an embodiment of the interconnection controller 11 in FIG. 1 or can be applied to the implementation of the interconnection controller 21 in FIG. 1. The interconnection controller 11A includes a link controller 105A for implementing the protocol layer (or “link layer”) and a physical layer circuit 101A for signal transmission. The link controller 105A includes, for example, a physical adapter (PA) layer circuit 110A and a data link (DL) layer circuit 120A, and so on. In particular, the PA layer circuit 110A includes a power mode management module M1A. The power mode management module M1A is used for performing power mode management, which can be implemented based on one or more embodiments of FIGS. 2, 3, 4, 5, 6, 7, or 8 or related examples.

The following provides various embodiments for implementation of controllers, apparatuses, devices, and system with the power mode management as illustrated in one or more above embodiments.

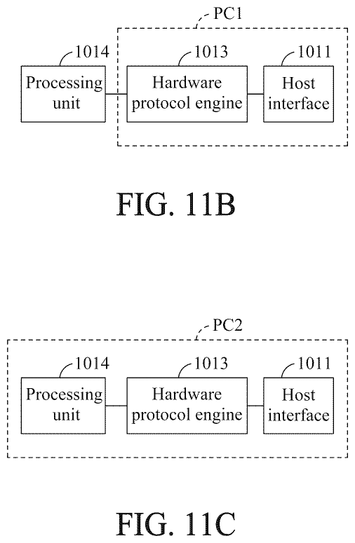

Referring to FIG. 11A, a diagram of circuit architecture is shown according to an embodiment of the present disclosure. As shown in FIG. 11A, a storage system 1000 includes a host 1010 and a storage device 1020. The host 1010 and the storage device 1020 communicate through an interconnection protocol, thereby allowing the host 1010 to perform data access of the storage device 1020. In addition, one or more of the embodiments of FIGS. 1, 2, 3, 4, 5, 6, 7, or 8 or related examples regarding power mode management, whenever appropriate, can be applied to the circuit architecture of FIG. 11A or its related examples such as FIG. 11B or FIG. 11C. According to the circuit architecture in FIG. 11A, the foregoing technique about the power mode management is applicable to a first device 10 of one or more of the embodiments above capable of communicating with a second device 20 of one or more of the embodiments above according to the interconnection protocol, wherein the host 1010 and storage device 1020 can be used to implement the first device 10 and second device 20 respectively, or vice versa. In the circuit architecture of FIG. 11A, a controller in the host 1010 or the storage device 1020 used to implement the interconnection protocol may be implemented by various configurations. As shown in FIG. 11A, the controller (for example, a host controller 1012) in the host 1010 used to implement the interconnection protocol or the controller (for example, a device controller 1022) in the storage device 1020 used to implement the interconnection protocol can be implemented as circuit architecture including a hardware protocol engine and a processing unit, wherein the processing unit of the controller is optional. In another example, as shown in FIG. 11B, the controller in the host 1010 used to implement the interconnection protocol is referred to as, for example, a protocol controller PC1, which can be configured to include a host interface 1011 and a hardware protocol engine 1013 and be implemented as a single chip, wherein a processing unit 1014 may be regarded as an external circuit of the protocol controller PC1. Moreover, similarly, the controller (or referred to as a protocol controller of the storage device 1020) in the storage device 1020 used to implement the interconnection protocol can be configured to include a device interface 1021 and a hardware protocol engine 1023 and be implemented as a single chip, wherein a processing unit 1024 may be regarded as an external circuit of the protocol controller. For another example, as shown in FIG. 11C, the controller in the host 1010 used to implement the interconnection protocol, for example, a protocol controller PC2, can be configured to include the host interface 1011, the hardware protocol engine 1013 and the processing unit 1014, and be implemented as a single chip. Moreover, similarly, the controller (or referred to as a protocol controller of the storage device 1020) in the storage device 1020 used to implement the interconnection protocol can be configured to include the device interface 1021, the hardware protocol engine 1023, and the processing unit 1024, and be implemented as a single chip. Thus, according to the circuit architecture in FIG. 11A, the controller used to implement the interconnection protocol in the host 1010 or the storage device 1020 can be regarded to cover or represent the embodiment based on FIG. 11A, FIG. 11B, or FIG. 11C. The description of other examples related to FIG. 11A is also suitable for the embodiments based on FIG. 11A, FIG. 11B, or FIG. 11C.

The circuit architecture shown in FIG. 11A has sufficient flexibilities and can be efficiently configured to meet requirements of different products, so as to adapt to diversified designs of manufacturers for better product development. The host 1010 is, for example, a computing device such as a smartphone, a tablet computer, a multimedia device, or other electronic devices. The storage device 1020 is, for example, a storage device inside or outside the computing device, and is such as a storage device based on a non-volatile memory. The storage device 1020 is capable of being written with data under control of the host 1010 or providing written data to the host 1010. The storage device 1020 can be implemented as an internal memory device, memory card, solid state drive (SSD), or so on; however, the implementation of the present disclosure is not limited to the examples above.

The host 1010 includes the host interface 1011, the host controller 1012, and an application processor 1016.

The host interface 1011 implements a physical layer of the interconnection protocol so as to link to the storage device 1020. For example, the host interface 1011 implements a physical layer based on the M-PHY specification or its modified version, whenever appropriate.

The host controller 1012 is coupled between the host interface 1011 and the application processor 1016. When the application processor 1016 needs to perform data access of the storage device 1020, it transmits a corresponding access operation command or write data to the host controller 1012 and communicates with the storage device 1020 through the interconnection protocol, thereby completing data access of the storage device 1020.

The host controller 1012 includes, for example, the hardware protocol engine 1013 and the processing unit 1014, wherein the processing unit 1014 is optional.

The hardware protocol engine 1013 implements a link layer of the interconnection protocol. The link layer can be implemented according to a modified version of UniPro as exemplified above. The hardware protocol engine 1013 communicates with the host interface 1011 and the processing unit 1014 and performs data conversion according to the specification of the link layer. In addition, the hardware protocol engine 1013 (or the host controller 1012) can be regarded as an embodiment of the link controller 105 of the first device 10 shown in FIG. 1, or can be based on one or more of the embodiments of FIGS. 1-10 or related examples, whenever appropriate.

The processing unit 1014 is coupled to the hardware protocol engine 1013, and communicates with the application processor 1016. The processing unit 1014 can execute one or more pieces of firmware. For example, an access operation command or write data output by an operating system, a driver, or an application executed by the application processor 1016 is converted into a command or data in a format compliant with the link layer of the interconnection protocol by the firmware executed by the processing unit 1014, and is then output to the hardware protocol engine 1013 for processing according to specification of the link layer. Alternatively, read data returned by the storage device 1020 in response to a read command of the host 1010 is returned to the hardware protocol engine 1013 according to the specification of the link layer of the interconnection protocol, and is converted by the corresponding firmware executed by the processing unit 1014 into data in a format that is compliant with and readable by the operating system, driver, or application executed by the application processor 1016. The firmware can be stored, for example, in an internal memory of the processing unit 1014, or be stored in an internal memory of the host controller 1012, wherein the internal memory can include a volatile memory and a non-volatile memory. The processing unit 1014 is optional, that is, the task of the firmware above may be implemented in the hardware protocol engine 1013 in hardware.

The storage device 1020 includes the device interface 1021, the device controller 1022, and a storage module 1026.

The device interface 1021 implements a physical layer of the interconnection protocol to link to the host 1010. For example, the device interface 1021 is for implementing a physical layer based on the M-PHY specification or its modified version, whenever appropriate.

The device controller 1022 is coupled between the device interface 1021 and the storage module 1026. The device controller 1022 has functions corresponding to or similar to those of the host controller 1012 described above, with respect to the interconnection protocol. When the host 1010 issues and transmits an access operation command or write data to the storage device 1020 through the interconnection protocol, the device controller 1022 converts the received data into a corresponding access operation command or write data through the interconnection protocol so as to facilitate data access to be performed by the storage module 1026. Alternatively, the device controller 1022 returns, according to the link layer of the interconnection protocol, read data returned by the storage device 1020 in response to the read command of the host 1010 to the host 1010. The storage module 1026 includes, for example, a memory chip of one or more non-volatile memories, and is, for example, a flash memory chip. In one example, the storage device 1020 may further include a flash memory controller. The flash memory controller is coupled between the device controller 1022 and the storage module 1026, and can be configured to control write, read, or erase operations of the storage module 1026, and is capable of performing data exchange with the storage module 1026 through an address bus or a data bus. In another example, the flash memory controller may be further provided in the device controller 1022.

The device controller 1022 includes, for example, the hardware protocol engine 1023 and the processing unit 1024, wherein the processing unit 1024 is optional.

The hardware protocol engine 1023 implements a link layer of the interconnection protocol. The link layer can be implemented according to a modified version of UniPro as exemplified above. The hardware protocol engine 1023 communicates with the device interface 1021 and the processing unit 1024 and performs data conversion according to the specification of the link layer. In addition, the hardware protocol engine 1023 (or the device controller 1022) can be regarded as an embodiment of the link controller 205 of the second device 20 shown in FIG. 1, or can be based on one or more of the embodiments of FIGS. 1, 2, 3, 4, 5, 6, 7, or 8, or related examples, whenever appropriate.

The processing unit 1024 is coupled to the hardware protocol engine 1023, and communicates with the host 1010 through the device interface 1021. The processing unit 1024 can execute one or more pieces of firmware. For example, the processing unit 1024 executes one or more pieces of firmware to communicate with the above flash memory controller, so as to exchange data such as an access operation command, write data or read data between the interconnection protocol and the flash memory controller. The firmware can be stored, for example, in an internal memory of the processing unit 1024, an internal memory of the device controller 1022, or a predetermined storage region of the storage module 1026, wherein the internal memory can include a volatile memory and a non-volatile memory.

As shown in FIG. 11A, the host interface 1011 can be coupled to the device interface 1021, for example, through data lines Din and Dout for transmitting or receiving data, a reset line RST for transmitting a hardware reset signal, and a clock line CLK for transmitting a clock signal. The data lines Din and Dout can be implemented in multiple pairs, wherein one pair of data lines Din or one pair of data lines Dout can be referred to as a lane for transmitting differential signals, for example. The host interface 1011 can communicate with the device interface 1021 by using at least one interface protocol; however, the implementation of the disclosure is not limited to the examples above.

A modified version of the UFS standard is taken as an example of the interconnection protocol. The UFS standard includes a UFS command set (UCS) layer, a UFS transport (UTP) layer, and a UFS interconnect (UIC) layer. The UIC layer includes a link layer and a physical layer. In the interconnection protocol, the link layer of the UIC layer can be implemented according to a modified version of the UniPro specification, and the physical layer of the UIC layer can be implemented according to a modified version of the M-PHY specification.

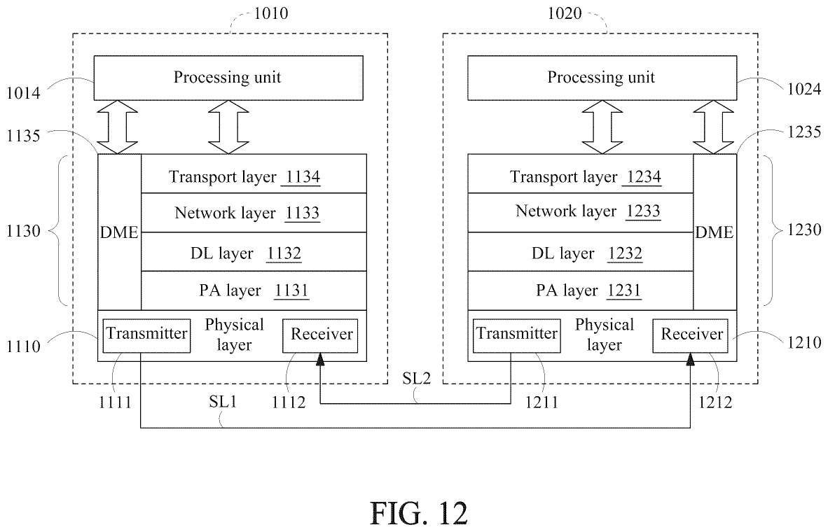

Referring to FIG. 12, a schematic diagram of layered architecture of the storage system in FIG. 11A is shown according to the UFS standard. Because the UFS standard is based on the MIPI UniPro layer and the MIPI M-PHY layer, the host interface 1011 and the hardware protocol engine 1013 of the host 1010 shown in FIG. 11A are respectively used to implement a modified physical layer 1110 and a modified UniPro layer 1130 in FIG. 12. Also, the device interface 1021 and the hardware protocol engine 1023 of the storage device 1020 in FIG. 11A are respectively used to implement a modified physical layer 1210 and a modified UniPro layer 1230 in FIG. 12. In addition, one or more of the embodiments of FIGS. 1, 2, 3, 4, 5, 6, 7, or 8 or related examples regarding the power mode management, whenever appropriate, can be applied to the layered architecture of FIG. 12.

As shown in FIG. 12, the modified UniPro layer 1130 (or 1230) can include a modified physical adapter (PA) layer 1131 (or 1231), a data link (DL) layer 1132 (or 1232), a network layer 1133 (or 1233), and a transport layer 134 (or 1234). The layers in the modified UniPro layer 1230 of the storage device 1020 can also similarly operate and be implemented.

The modified physical adapter layer (1131 or 1231) couples the modified physical layer (1110 or 1210) to the data link layer (1132 or 1232). The modified physical adapter layer (1131 or 1231) is capable of performing bandwidth control and power management between the modified physical layer (1110 or 1210) and the data link layer (1132 or 1232). In practice, the modified physical layer 1110 of the host 1010 includes a transmitter (TX) 1111 and a receiver (RX) 1112, and the modified physical layer 1210 of the storage device 1020 includes a transmitter (TX) 1211 and a receiver (RX) 1212, thereby establishing data lanes SL1 and SL2 to perform full duplex communication. The modified UniPro specification may support multiple data lanes for a link in each transmission direction (for example, forward or backward).

The data link layer (1132 or 1232) is capable of performing flow control of data transmission between the host 1010 and the storage device 1020. The data link layer is capable of performing error detection and re-transmission of a frame in case of errors, according to one or more of the embodiments above.

The network layer (1133 or 1233) is used to select a routing function for a transmission path for the packets received from the transport layer (1134 or 1234).

The transport layer (1134 or 1234) can use a command received from the UFS application layer to configure a data segment suitable for the protocol and transmit the data segment to the network layer (1133 or 1233), or can extract a command from packets received from the network layer (1133 or 1233) and transmit the command to the UFS application layer.

Moreover, the modified UniPro layer (1130 or 1230) can be further implemented with a device management entity (DME) (1135 or 1235), which can communicate with the layers in the modified physical layer (1110 or 1210) and the modified UniPro layer (1130 or 1230), for example, the modified physical adapter layer (1131 or 1231), the data link layer (132 or 232), the network layer (1133 or 1233), and the transport layer (1134 or 1234), so as to communicate with the UFS application layer, thereby implementing the modified or higher version of UniPro overall functions such as control or configuration functions including power-on, power-off, reset, and power mode change.

Accordingly, one or more of the embodiments of FIGS. 1, 2, 3, 4, 5, 6, 7, or 8 or related examples regarding the power mode management can be applied to the embodiments of FIG. 11A, FIG. 11B, FIG. 11C, or FIG. 12 to perform operations according to one or more of the embodiments of FIGS. 1, 2, 3, 4, 5, 6, 7, or 8 or one or more related embodiments or examples, whenever appropriate.

In the present disclosure, “asserting” a signal (or other alternative forms such as “asserted” or “assertion”) means that a signal is set to be in an active state, which may be an active voltage level in a high or low level, or may be a signal in an associated form. “De-asserting” a signal (or other alternative forms such as “de-asserted” or “de-assertion”) means that a signal is set to be in an inactive state, which may be an inactive voltage level in a low or high level, or may be a signal in another associated form. If a signal is set to be at a low level to represent active-low, “asserting” the signal means that the signal is set to a low level, and “de-asserting” the signal means that the signal is set to a high level. If a signal is set to be at a high level to represent active-high, “asserting” a signal means that the signal is set to a high level, and “de-asserting” the signal means that the signal is set to a low level.

Moreover, in the embodiments related to the host and the storage device above, the hardware protocol engine in the host controller or the device controller can be designed based on Hardware Description Language (HDL) such as Verilog, SystemVerilog, or techniques of any other design methods of digital circuits generally known to a person skilled in the art, and can be implemented by one or more of circuits based on such as a field programmable gate array (FPGA), an application-specific integrated circuit (ASIC), or a complex programmable logic device (CPLD), or be implemented by a dedicated circuit or module. The host controller or the device controller (or a processing unit or a hardware protocol engine therein) can also be based on a microcontroller, a processor, or a digital signal processor (DSP).

The present disclosure is described by using the embodiments above. A person skilled in the art should understand that, these embodiments are merely for describing the present disclosure are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. A method for power mode management of an interconnection protocol in an electronic device, the method comprising steps of:
a) determining, by the electronic device, a power mode for a forward link, based on version information of the interconnection protocol of another electronic device, wherein the version information of the interconnection protocol of the another electronic device is obtained in a first stage of link initialization; and
b) operating, by the electronic device, in the power mode for the forward link for a second stage of the link initialization following the first stage of the link initialization.

2. The method according to claim 1, wherein in the step a), the version information indicates that a version value of the interconnection protocol used in the another electronic device is equal to or greater than a version threshold, and the power mode for the forward link is determined as a first transmission mode in which the forward link is ready to transmit data without autonomously being switched to be inactive.

3. The method according to claim 2, wherein the method further comprises:
c) opening, by the electronic device, a burst for the forward link in the first transmission mode for the second stage of the link initialization; and
d) maintaining, by the electronic device, the burst opened for the forward link until a condition which requires burst closing is detected.

4. The method according to claim 3, wherein the condition which requires burst closing is one of a power mode change, a hibernate entry, or an error handling condition.

5. The method according to claim 2, wherein the interconnection protocol is based on a Unified Protocol (UniPro); the version threshold indicates a version number higher than version 2.0; and the first transmission mode is a fast mode of the UniPro.

6. The method according to claim 5, wherein the first stage of the link initialization is a process for link startup for a physical adapter layer and the second stage of the link initialization is data link layer initialization.

7. The method according to claim 1, wherein in the step a), the version information indicates that a version value of the interconnection protocol used in the another electronic device is less than a version threshold, and the power mode for the forward link is determined as a second transmission mode in which the forward link is ready to transmit data and is autonomously being switched to be inactive when no data is to be transmitted.

8. The method according to claim 7, wherein the interconnection protocol is based on a Unified Protocol (UniPro); the version threshold indicates a version number higher than version 2.0; and the second transmission mode is a fast auto mode of the UniPro.

9. An electronic device comprising:
an interconnection controller including:
a physical layer circuit for signal transmission; and
a link controller, coupled to the physical layer circuit,
wherein the interconnection controller is configured to perform a plurality of operations including:
a) determining a power mode for a forward link, based on version information of an interconnection protocol of another electronic device, wherein the version information of the interconnection protocol of the another electronic device is obtained in a first stage of link initialization; and
b) operating in the power mode for the forward link for a second stage of the link initialization following the first stage of the link initialization.

10. The electronic device according to claim 9, wherein in the operation a), the version information indicates that a version value of the interconnection protocol used in the another electronic device is equal to or greater than a version threshold, and the power mode for the forward link is determined as a first transmission mode in which the forward link is ready to transmit data without autonomously being switched to be inactive.

11. The electronic device according to claim 10, wherein the plurality of operations further includes:
c) opening a burst for the forward link in the first transmission mode for the second stage of the link initialization; and
d) maintaining the burst opened for the forward link until a condition which requires burst closing is detected.

12. The electronic device according to claim 11, wherein the condition which requires burst closing is one of a power mode change, a hibernate entry, or an error handling condition.

13. The electronic device according to claim 11, wherein the interconnection protocol is based on a Unified Protocol (UniPro); the version threshold indicates a version number higher than version 2.0; and the first transmission mode is a fast mode of the UniPro.

14. The electronic device according to claim 13, wherein the first stage of the link initialization is a process for link startup for a physical adapter layer and the second stage of the link initialization is data link layer initialization.

15. The electronic device according to claim 9, wherein in the operation a), the version information indicates that a version value of the interconnection protocol used in the another electronic device is less than a version threshold, and the power mode for the forward link is determined as a second transmission mode in which the forward link is ready to transmit data and is autonomously being switched to be inactive when no data is to be transmitted.

16. The electronic device according to claim 15, wherein the interconnection protocol is based on a Unified Protocol (UniPro); the version threshold indicates a version number higher than version 2.0; and the second transmission mode is a fast auto mode of the UniPro.
